(19) United States
(12) Patent Application Publication
(10) Pub. No.: US 2026/0050329 A1
(43) Pub. Date: Feb. 19, 2026

(54) CREATION AND PLAYBACK OF IMMERSIVE PRESENTATIONS OF MEMORIES AS DIGITAL ASSETS TO AID IN CARE OF INDIVIDUALS WITH NEURODEGENERATIVE DISEASES

(71) Applicant: Reminisequence, Inc., Edgewater, MD (US)

(72) Inventor: Sean Geoffrey O'Sullivan, Edgewater, MD (US)

(21) Appl. No.: 19/300,654

(22) Filed: Aug. 14, 2025

Related U.S. Application Data
(60) Provisional application No. 63/683,073, filed on Aug. 14, 2024.

(51) Int. Cl. G06F 3/01; G06F 21/10; H04N 21/81

(52) U.S. Cl. CPC G06F 3/015; G06F 21/107; H04N 21/8146

(57) ABSTRACT

A system and method for collecting information about memories of individuals that can be used to treat them if they develop neurodegenerative disease. Users upload multimedia memory content. Artificial intelligence gathers additional information about the memories and assists in structuring the memory and generating immersive presentations incorporating visual elements and optionally one or more sensory modalities including touch, smell, hearing, taste, moisture, nervous system sensations, and temperature. The immersive presentation is then minted as a unique non-fungible token (NFT) or equivalent digital asset, enabling privacy, access control. The memories may be authenticated via biometric, contextual, or metadata-based verification

### PRIORITY

This application claims the priority under 35 USC § 119 of U.S. Provisional Application 63/683,073 filed on Aug. 14, 2024. Application 63/683,073 is herein incorporated by reference in its entirety.

### BACKGROUND

Individuals encounter many experiences during their lifetime. The experiences may be for just the individual or may also include for example family, friends and/or co-workers. The experiences may include, but are not limited to, daily activities (e.g., family dinners, dates, kids first steps), specific activities partook in (e.g., weddings, birthdays, sporting events, vacations) or may be specific events attended (e.g., concerts, sporting events, shows, parades). These experiences are captured in the memory of the individual and may also be captured by pictures, videos, audios, notes and/or mementos (e.g., ticket stub, currency, souvenir).

The memories of these experiences may be good or may be bad. The memories may elicit different emotions from the individual as they experience the event initially as well as when they remember the event later in time. The memories may be very vivid and include many details including specific details about the event being remembered and possibly specifics about feelings they had (e.g., sad, happy) or physical attributes they encountered (e.g., heart racing, sweating, feeling lightheaded). Alternatively, the memories may be grainy and only include limited details about the event or any feelings or physical attributes encountered during the event.

As the experience becomes further in the past, the individual's memory of the experience may begin to wane (e.g., some of the details may begin to fade). Furthermore, as the individual gets older and/or health concerns (e.g., dementia) become an issue, the memories may also begin to wane. In fact, if the individual is experiencing dementia the individual may begin to have issues with thinking and behavior in addition to memory. The ability to provide aids (e.g., pictures, videos, audios, notes, scents, tactile sensations) to help such an individual recall memories, may assist in their care.

Memories after often shared by the individual or individuals that experienced the event with others. In addition to telling the others about the event, the individual(s) may utilize other aids (e.g., pictures, videos, audios) to provide an insight into the experience. Regardless of how good a storyteller the individual is, or how good the aids are, the others may not get the same experience from the memory as the individual.

There is a need for capturing details about experiences and saving these details for later retrieval. This is a desire for enhancing the details captured about the experience to provide as close to real life memories thereof as possible. Moreover, there is a desire to create an interactive version of the real-life memory to replicate the experience as closely as possible. Additionally, there is a need to provide a manner to authenticate that the real-life memories were actually experienced. Furthermore, there is a need to store the real-life memories and provide an ability to relive these interactive real-life memories at a later time (e.g., by the individual whose experience it was, by family/friends of the individual, someone experiencing dementia who may be the individual who experienced the event, related to the individual, or a caregiver for the individual where the memories could help, other interested parties potentially willing to pay to experience the interactive real-life memories). Access to the stored real-life memories should be controlled.

### BRIEF DESCRIPTION OF FIGURES

The features and advantages of the various embodiments will become apparent from the following detailed description in which:

FIG. 1 illustrates a high-level block diagram of an example system, according to one embodiment.

FIG. 2 illustrates a high-level functional diagram of an example server utilized in an example system, according to one embodiment.

FIG. 3 illustrates a flow chart of an example process for capturing information related to a memory and creating an interactive real-life memory therefrom, according to one embodiment.

FIG. 4 illustrates a flow chart of an example process for securely validating the consolidated memory, securely storing the consolidated memory, creating ownership rights in the consolidated memory and controlling access thereto, according to one embodiment.

### DETAILED DESCRIPTION

A system is provided that can perform certain tasks including at least a subset of: (a) collect details about an experience that an individual (or individuals) had, (b) utilize artificial intelligence to gather additional information about the experience from public sources, if available, (c) integrate the public information with the collected details to create a memory close to real life, (d) create an interactive version of the real life memory, (c) authenticate the interactive real life memories, (f) encrypt the interactive real life memories, (g) store the encrypted interactive real life memories, (h) control access to the stored memories, and (i) provide ability to experience the interactive real life memories.

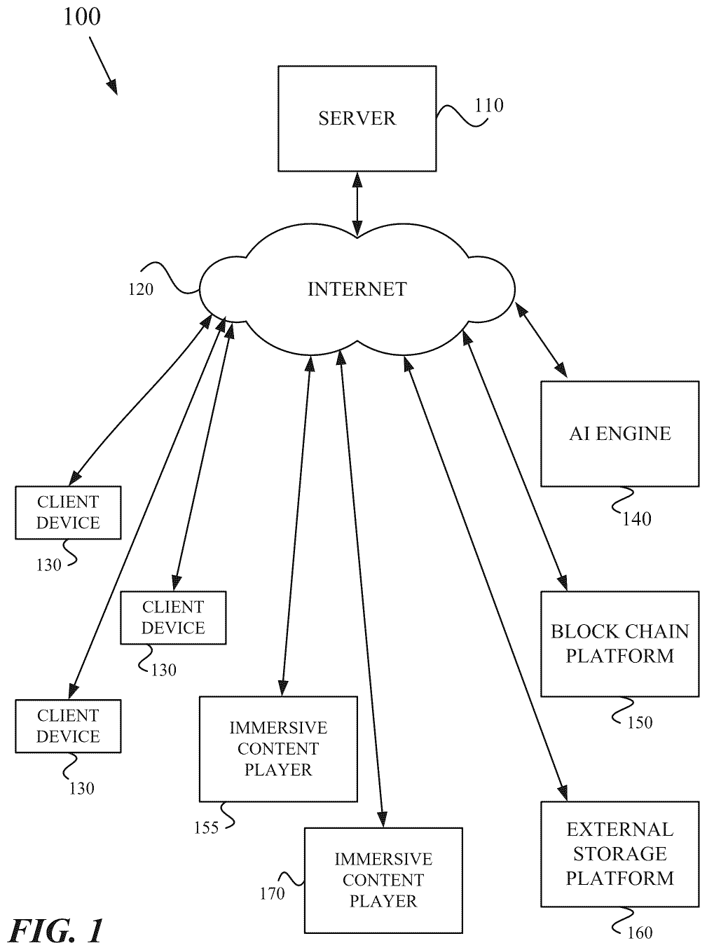

FIG. 1 illustrates a high-level block diagram of an example system 100. The system 100 includes a server 110 that communicates via the Internet 120 with a plurality of client devices 130 (3 illustrated), an AI engine 140, a blockchain platform 150, an external storage platform 160 and a plurality of immersive content players 170 (2 illustrated). The server 110 may be centralized or distributed. The server 110 is designed to communicate (e.g., via the Internet 120) with the plurality of client devices 130 in order to provide them with the ability to capture information about memories from users thereof (e.g., individuals with the memories). The client devices 130 may be various Internet enabled devices including, but not limited to, wireless phones, tablets, laptops, desktops, and gaming systems. The server 110 is configured to provide software as a service (SAAS) to the plurality of client devices 130.

The server 110 is also designed to communicate (e.g., via the Internet 120) with the AI engine 140 in order to perform operations using the AI engine 140 to gather additional information, context and/or details about the memories captured by a client device 130. The AI engine 140 utilized may be a currently commercially available AI engine, which include, but are not limited to, CoPilot, ChatGPT, OpenAI, and MetaAI. According to one embodiment, the system 100 may include a specifically designed AI engine. The server 110 may provide the client device 130 with the additional information found in order to obtain confirmation from the users thereof. The server 110 may then utilize the AI engine 140 to create a consolidated memory that can be utilized to create an immersive presentation of the memory therefrom (immersive memory). The server 110 may provide the client device 130 with the consolidated memory so the user can either use the client device 130 or an immersive content player 170 to review the immersive presentation and confirm its accuracy.

The server 110 then encodes all of the information that makes up the immersive memory into a unified memory payload package (memory object) that is time stamped and content addressable via cryptographic hash (e.g., SHA-256) to ensure the authenticity of the data. The unified memory payload package may also be encrypted using, for example, an AES-256 or equivalent quantum-resistant algorithm (cryptographic key). The server 110 is also designed to communicate (e.g., via the Internet 120) with the external storage platform 160 and to provide the encrypted payloads thereto. The external storage platform 160 may be a decentralized, content-addressable file system (e.g., Arweave, IPFS, Filecoin), encrypted cloud storage, or a proprietary secure memory vault. Each unified memory payload package is stored immutably and indexed via its unique hash and the unified resource identifier.

As used herein, a memory object (e.g., the unified memory payload package), whether certified or non-certified, refers to any self-contained digital construct representing an authenticated, stored, and retrievable memory experience, including, but not limited to, a unified memory payload package as described herein. A memory object may incorporate media, metadata, cryptographic identifiers, and associated access controls, and may be embodied in various storage and registry formats now known or hereafter developed.

The server 110 also communicates with the blockchain platform 150 in order to provide a ledger of the creation of the unified memory payload package. The blockchain platform 150 utilized may be a currently commercially available platform, which include, but are not limited to, Bitcoin, Ethereum, Solona, Coinbase and EOS. According to one embodiment, the system 100 may include a specifically designed blockchain platform. While in certain embodiments the registry of ownership and access is implemented using a blockchain or distributed ledger, alternative immutable or tamper-evident registry technologies, including but not limited to directed acyclic graph ledgers, quantum-secure distributed systems, federated consensus registries, trusted execution environment attestation logs, or other future-developed methodologies, are also contemplated herein.

The blockchain platform 150 (other disturbed ledger platform, immutable/tamper-evident registry technology) may also create a smart contract for the unified memory payload package that identifies, for example, ownership, access permissions, licensing parameters, replay restrictions and expiration of unlocking conditions if required for any given unified memory payload. The blockchain platform 150 may mint a non-fungible token (NFT) for the unified memory payload package based on an immutable reference to the unified memory payload package (e.g., external storage platform universal resource identifier (URI)), metadata therefore and the smart contract logic. The metadata may include different parameters about the memory including, but not limited to, memory title, creator, timestamp, location, emotions, themes, and signature hash. The NFT for memory objects (unified memory payload packages) may be referred to as a Neural Experience NFT (nxNFT) as it provides for immersive presentations of the memory. When discussed herein, the NFT for the memory objects may be referred to either as NFT or nxNFT (they may be utilized interchangeably).

The server 110 may communicate with individuals desiring to experience the immersive memory. The immersive memory may be experienced using an immersive content player 170 and the sever 110 may communicate directly with the player 170 or via a client device 130. The immersive content player 170 may be a virtual reality (VR), augmented reality (AR) or mixed reality (MR) headset. Alternatively, the immersive content player 170 may be specialized displays and possibly software running on standard displays to create the immersive experience without the need for the headset. The immersive presentation may include different sensations in addition to vision, including but not limited to, touch, smell, moisture, and temperature. It is envisioned that in the future, the immersive content player 170 may provide direct-to-brain playback using various forms of contact and/or non-contact brain-machine interface technology, as well as other human-machine interface and interaction modalities, including, but not limited to, haptic, olfactory, thermal, and other sensory output systems.

As used herein, the term “human-machine interface” or “human-machine interaction” (collectively, HMI) refers to any hardware, software, firmware, or combination thereof that facilitates unidirectional or bidirectional or multidirectional communication, control, or sensory exchange between one or more human users and a computational or electromechanical system. HMI encompasses, without limitation, brain-machine interfaces (BMI), contact or non-contact neural interfaces, haptic feedback devices, olfactory and gustatory output systems, temperature and environmental control elements, gesture or motion tracking systems, wearable displays (including VR, AR, MR, and XR devices), audio output systems, and any future-developed modalities capable of conveying sensory input to or receiving control input from a human user.

The individuals may be the individual who created the memory, family members thereof, caregivers therefore, or other parties. The owner of the NFT may utilize the NFT to decrypt and validate the unified memory payload package. If the memory is being experienced by someone other than the owner, the NFT (nxNFT) may be sold, transferred, rented or the like by the owner. The smart contract that is part of the NFT (nxNFT) will define the associated parameters.

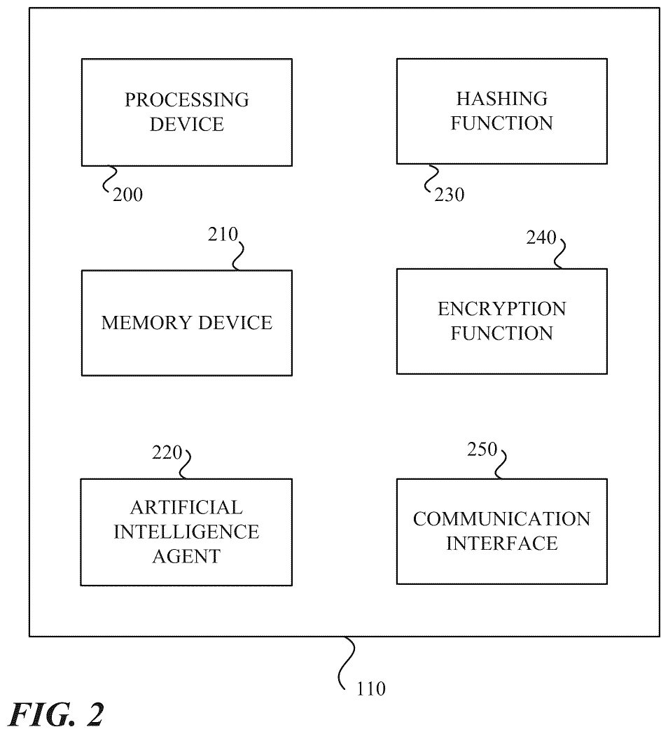

FIG. 2 illustrates a functional diagram of the server 110. The server 110 includes a processing device 200, a memory device 210, an artificial intelligence (AI) agent 220, a hashing function 230, an encryption function 240 and a communications interface 250. It should be noted that the various components are illustrated as single components (for case of illustration) but are in no manner intended to be limited thereto. Rather, the server 110 may include a plurality of any or all of the various components. If a plurality of any of the components are utilized, the components may be the same or may be different. The server 110 may include other functional components that are not illustrated.

The processing device 200 may be one or more servers (e.g., web servers, database servers, mail servers, file servers or combinations thereof), computers, processors, or the like, or various combinations thereof. The processing device 200 controls the overall operation of the server 110. The memory device 210 may store data and processor readable instructions. The processing device 200 may read the processor readable instructions from the memory device 210. The processor readable instructions when executed by the processing device 200 cause the processing device 200 to perform different operations including at least a subset of tasks (a)-(i) discussed above and described in more detail later.

The AI agent 220 is designed to utilize the AI engine 150 to process large amounts of data, interpret the data, learn from the data, and provides responses based on information provided thereto. The information provided thereto includes information related to different experiences (memories) and the data that is processed includes publicly available data related to the experience. The AI agents 220 may also provide content generation.

The hashing function 230 is designed to cryptographically hash (e.g., SHA-256) the unified memory payload package. The cryptographic hash of the payload is utilized to validate the authenticity of the payload. The hashing function 230 may be provided by hardware or software. The encryption function 240 is designed to encrypt, using an AES-256 or similar quantum-resistant algorithm, the unified memory payload package so that it cannot be utilized without the decryption key. The encryption function 240 may be provided by hardware or software.

The communications interface 250 may enable communications between the server 110 and other systems and devices including the client devices 130, the AI engine 140, the blockchain platform 150, the external storage platform 160 and the immersive content players 170. The communications interface 130 may provide wired and/or wireless communications utilizing various protocols.

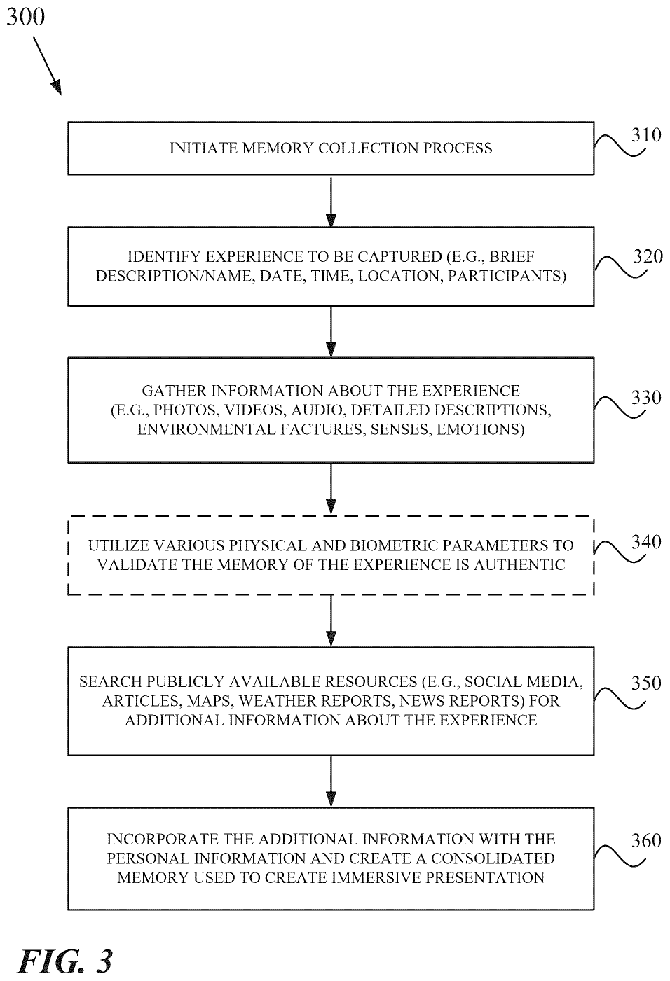

FIG. 3 illustrates a flow chart of an example process for capturing information related to a memory and creating a static or an interactive real-life memory therefrom 300. The process 300 starts when an individual initiates a memory collection process 310. The memory collection process may be initiated on a client device 130 (e.g., phone, tablet, laptop) by, for example, opening an app associated with the memory collection process. The app may communicate with the server 110. The client device 130 may be utilized to collect information about an experience that the individual has had. The experience may be an intimate experience such as a date with a spouse or a family vacation. The experience may be participating in an event (e.g., wedding, concert, sporting event, show, parade). The experience may have happened in the past and recollections about the experience are being captured. Alternatively, the individual may be partaking in the experience currently and may be capturing certain information about the experience in real time. The client device 130 may provide a user interface (UI), for example a graphical UI (GUI), that can be utilized to collect information about the experience.

Initially, the individual identifies the experience that they will be capturing 320. The identifying includes capturing some general information about the experience including for example, a brief description (e.g., name), date, time, location, and participants that can be used for identification and indexing purposes. The UI may prompt the individual for the general information needed to identify and index the experience. The UI may enable the information to be entered in various manners, including for example, entering via a keyboard or spoken into a microphone. According to one embodiment, it is possible the information is provided using brain machine interface technology.

Once the experience has been identified, information about the experience is gathered 330. The information gathered may include, but is not limited, to detailed descriptions (verbal and/or written), pictures, videos, audios, drawings and notes. The detailed descriptions may include, but is not limited, details related to the experience, location/venue, participants, environmental factors (e.g., temperature, humidity, precipitation, light, smell), personal factors (e.g., feclings, mood, emotions) and physical factors (e.g., touch, heart rate, perspiration, body temperature). The client device 130 may enable some of the information (e.g., videos, photos, audio, drawings, notes) to be uploaded.

Accessories may be utilized to capture certain information. The accessories may include, but are not limited to, microphones, scanners, recorders (video and/or audio), cameras, and various sensors. Some accessories may be part of the client device 130 (e.g., camera, microphone), some may be connectable to the client device 130 and enable information to be directly provided thereto, while others may be separate from the client device 130 and provide the information captured thereby to the client device 130 in some fashion (e.g., upload, enter, transmit).

The sensors may measure various parameters including, but not limited to, temperature, pulse, heart rate, blood pressure, and sweat level. The parameters captured may be used to infer emotions and/or feelings the individual may have experienced while recounting the memory (and these inferred feelings and physical parameters may have also been experienced when having the initial experience they are recounting).

According to one embodiment, the individual recounting the memory may be hooked up to different devices that may monitor brain waves. The brain waves may be used to interpret different parameters associated with recounting the memory (and presumably experienced during the initial experience). According to one embodiment, it is envisioned that future implementations may capture a real time snapshot of the brain's molecular and quantum states, decoding emotional signatures and visualized thoughts by analyzing the atomic and subatomic choreography of neural activity associated with the memory.

The devices may include, for example, a wired neural interface, a wireless brain-machine interface, a quantum brain interface, an energetic biofield interface, a bio-sensory neural interface and other future devices capable of capturing brain waves in some manner. Some of these devices are currently available while others are in development and/or are theoretical at this point. The wired neural interface includes neural implants in the individual and direct wiring to a computational device. It is envisioned that most individuals uploading information about their experiences will not be equipped with neural implants. The wireless brain-machine interface includes neural signals being transmitted wirelessly using electromagnetic fields. The quantum brain interface utilizes quantum entanglements and/or tunneling effects to facilitate real time communication between the brain and an advanced quantum computer. This may enable non-local interactions between the brain and computer. The energetic biofield interface is currently a speculative technology where the brain's biofield interacts with an external system to facilitate non-physical data exchange. The bio-sensory neural interface enables the brain's sensory inputs to directly interface with computational devices. In some embodiments, future implantable or non-invasive, non-contact BMI systems may leverage the proposition, and related theories, that consciousness involves quantum processes in neuronal microtubules, thereby enabling interaction with cognitive substrates at both classical and quantum levels for enhanced memory capture and restoration.

If multiple individuals were part of the experience, information may be gathered from the other participants. According to one embodiment, conflicting information may be flagged and presented to the individuals providing conflicting information. The individuals may be able to determine if there is an actual conflict or just the information being different because it captures a different part or perspective of the experience. If the conflict isn't real, the individuals may provide additional information to the system to resolve the conflict flag. By way of example, if one individual was describing the view of the stands at a baseball game and another was describing the view of the field neither recollection is wrong they are just from a different perspective and that needs to be defined. Likewise, maybe one individual described a specific play and the other didn't. Accordingly, the fact that one describes the play and one does not, is not a conflict.

If there is an actual conflict, the individuals may determine which set of information is accurate or if each set of information needs to be revised. For example, if one individual said they were five rows back from the stage at the concert and the other individual said they were twenty rows back and this discrepancy is presented one individual may agree they were exaggerating and that they were actually probably twenty rows back. Alternatively, they could each agree that they were likely 10-15 rows back. According to one embodiment, if more individuals agreed with one set of information than the other, that set of information may be utilized. By way of the concert example, if three individuals said 15-20 rows and one said 5-10 rows, the system would go with the 15-20 rows description. According to one embodiment, as the system evolves to compare authenticity datasets for any given memory or experience to memories in the database in general, using benchmarking and AI comparison tools, the system could have an override where a minority version gets extra weighting in the decision regarding what is real.

After any conflicts are resolved in the case of multiple individuals providing information about the experience, the information from each of the participants may be consolidated.

According to one embodiment, certain parameters captured by one or more of the sensors may optionally be utilized to validate the memory 340. That is, one or more of the various parameters may be compared to benchmark parameters to determine the likelihood that the information provided was real and accurate. The benchmark parameters may be for the general population, a portion of the population having similar traits (e.g., age, sex, race, ethnicity) to the individual, or for the individual. The benchmarks for the individual may be determined by using the sensors to capture the various parameters to known questions where it is known in advance if the individual is, for example, telling the truth, exaggerating, or lying. There may be benchmark parameters for various situations and the comparison of the various parameters needs to be performed based on the appropriate benchmarks. For example, a person's heart rate may spike when they are not telling the truth, but it may also spike if they are describing an exhilarating event.

After the information gathering is complete, the information used to identify the experience (e.g., brief description, date, time, location, participants) and possibly some additional information about the experience may be provided to the AI agent 140 in order to gather additional information about the experience from publicly available resources 350. The publicly available information may come from various sources including, but not limited to, social media, news reports, weather reports, maps, and publications. The publicly available information collected may include, but is not limited to, pictures or video of the experience, descriptions of the experience, and weather details for the day.

For example, if the experience is about a wedding that was held on a certain day at a certain location, the AI agent 140 may find information about the weather that day and the venue. The information about the venue may include maps and pictures of the venue as it existed at or around the time of the event. The AI agent 140 may also find pictures or videos that other attendees of the wedding may have posted on their social media. The additional information may provide more details regarding the wedding including, for example, the venue, the weather and/or the attendees.

By way of another example, if the experience was about a parade that the individual attended when they were younger, the AI agent 140 may gather publicly available information about the parade. The information gathered may include, for example, weather, parade route, order of floats in the parade, maps of the venue where the parade is held, photos or videos of the parade, descriptions of the parade from others. The additional information may provide more details regarding the parade including, for example, the crowd, the city streets, the weather and/or the acts in the parade.

According to one embodiment, additional information found by the AI agent 140 that appears to conflict with the information provided by the individual (or individuals) may be flagged. The conflicting information may be provided to the individual(s) and the individual(s) may provide feedback in an attempt to resolve the discrepancies. For example, maybe the individual realizes that they provided the wrong date, time or the like for the event so that the AI agent 140 gathered additional information that was not associated with the experience being described. The individual may correct the erroneous information they provided so that the AI agent 140 can gather accurate information. By way of another example, the individual may determine that the AI agent 140 found relevant information that is not exactly germane to the specific experience as the description of the experience may have been too vague. Accordingly, the individual may provide more details so the AI agent 140 can provide updated information. By way of another example, the additional information provided by the AI agent 140 may refresh the individual's memory and they may update the information they provided. For example, if the additional information states that it was raining that day the individual may realize that it was in fact raining that day and amend their description as such (or simply approve the alternative description provided by the AI agent 140).

According to one embodiment, the AI agent 140 may present the additional information that was found about the experience to the individual. The individual may have the ability to accept or reject the additional information. If the personal information about the experience was provided by more than one individual, the additional information from the AI agent 140 may be presented to each of the individuals. According to one embodiment, the parties will need to reach a consensus about the additional information that is added. Alternatively, the main person presenting the memory of the experience may be the default person to decide.

After any conflicts are resolved, the additional information gathered by the AI engine may be incorporated with the personal information gathered to create a consolidated memory that can be utilized to create an immersive presentation of the memory therefrom (immersive memory) 360. The consolidated memory may provide more complete descriptions of, for example, the event, the weather, the scenery, and the attendees. The consolidated memory may include additional photographs, videos or the like. The consolidated memory may provide a perspective not captured by the personal information. For example, in the parade example the individual noted that there were about 10 people from the street, and they were on their dad's shoulders. The consolidated memory may, for example, adjust photos and/or videos or add images of associated with a child on their fathers' shoulders to provide that perspective. The consolidated memory may rearrange the order of the personal information provided or add additional items in the appropriate location. For example, if the individual describes some of the floats that they saw the additional information may be able to put the individual's recollection in the correct order and possibly add details about floats not noted or captured in photos or video provided by the individual.

The consolidated information may be presented to the individual as an immersive presentation. The immersive presentation may make someone interacting therewith feel like they are partaking in the experience. The extent of the immersive presentation may depend on the information provided/gathered, the service level signed up for and the type of device being utilized to experience the immersive presentation. According to one embodiment, the immersive presentation may be a video that may be presented on a display (e.g., phone, tablet, computer, television, wearable display glasses (smart glasses)). According to one embodiment, the immersive presentation may be a virtual reality (VR), augmented reality (AR) or mixed reality (MR) presentation of the experience. These immersive experiences may provide an individual experiencing the immersive presentation feel like they are actually part of the experience. For example, in the parade example previously discussed an individual experiencing the immersive presentation may feel like they are on someone's shoulders as they take in the parade and everything therearound. The immersive presentation may include different sensations in addition to vision, including but not limited to, touch, smell, moisture, and temperature.

The immersive VR, AR or MR presentations may be designed to be used with AR or VR headsets. Alternatively, the immersive VR, AR or MR presentations may be designed to be used with systems that do not include headsets but rather mimic the experience by, for example, using specialized displays, non-contact VR, and possibly software running on standard displays. It is envisioned that in the future, the presentations may be designed to be experienced via direct-to-brain playback using various forms of contact and/or non-contact brain-machine interface technology, as well as other human-machine interface and interaction modalities, including, but not limited to, haptic, olfactory, thermal, and other sensory output systems.

The individual may determine if they approve the consolidated memory as it is presented in the immersive presentation on the device available to them. It is possible that the individual views an immersive presentation on the client device 130 as a simple video where it may be displayed more life-like and interactive on a VR or AR device. If there are errors in the immersive presentation the individual may identify the errors that need to be fixed. For example, if the immersive presentation shows an image of the crowd cheering wildly after a play in the middle of the game instead of the game winning catch, the individual may provide commentary that the order of the immersive presentation is not accurate. The individual may determine that the immersive presentation could utilize additional information. For example, the individual may provide narration or a soundtrack for the immersive presentation.

The immersive presentations are not limited to being designed for any specific type or brand of equipment. Rather, they would be designed such that they can be used by various currently known technologies. Likewise, it is anticipated that they would be capable of easily adapting to any future technologies discovered. It is possible, as technology advances that some type of interface may be required to have the immersive presentations currently created be presented on these new technologies that may in future embodiments, for example, have the end-user experience the immersive memory presentation through contact or non-contact brain-machine interface technology, or other human-machine interaction systems designed to engage multiple senses such as touch, smell, taste, temperature, and motion.

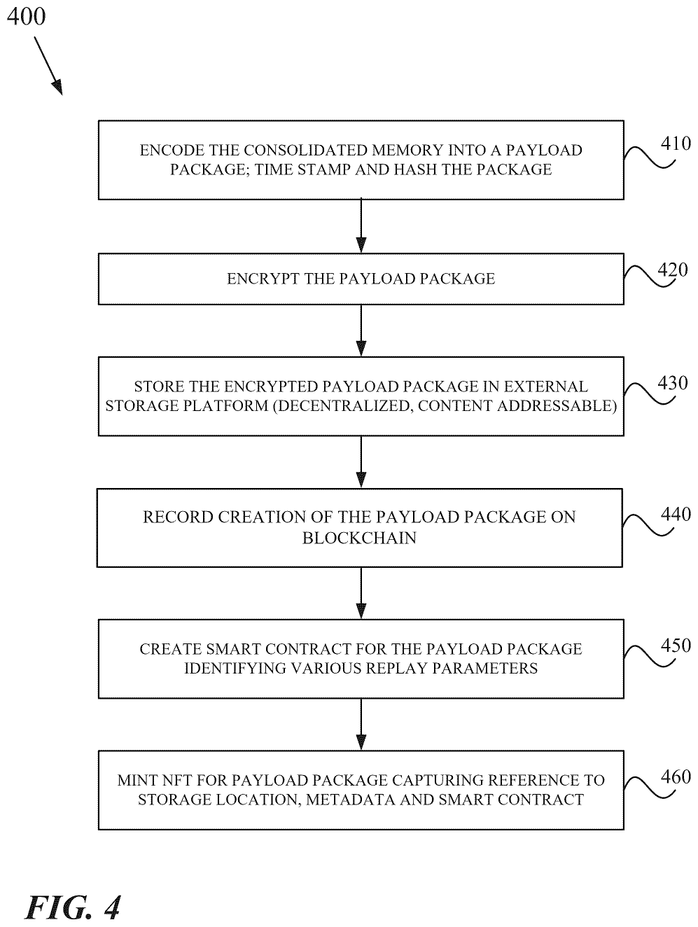

FIG. 4 illustrates a flow chart of an example process 400 for securely validating the consolidated memory, securely storing the consolidated memory, creating ownership rights in the consolidated memory and controlling access thereto. Once the immersive presentation is complete all the information that makes up the immersive memory is encoded into a unified memory payload package 410. The package is time stamped and is cryptographically hashed using a hash key (e.g., SHA-256) and the hash value is stored in the payload. As one skilled in the art would know, the hash value is used to authenticate the validity of the data. Before the payload is used it will be cryptographically hashed and the hash value generated will be compared to the stored hash value. If the values are the same that payload is the same as it was when it was created (e.g., it has not been tampered with or corrupted). If the hash values are different the payload is not the same (e.g., has been tampered or corrupted).

The encoded payload is then encrypted using an algorithm and an encryption key (e.g., AES-256) to transform the payload into an unreadable format (ciphertext) 420. The cipher text is then stored on an external storage platform 430. The external storage platform may be a decentralized, content-addressable file system (e.g., Arweave, IPFS, Filecoin), encrypted cloud storage, or a proprietary secure memory vault. Each unified memory payload package is stored immutably and indexed via its unique hash and the unified resource identifier.

The creation of the unified memory payload package is recorded on the blockchain 440. A smart contract is created for the unified memory payload package, and the smart contract is recorded on the blockchain 450. The smart contract identifies, for example, ownership, access permissions, licensing parameters, replay restrictions and expiration of unlocking conditions if any. The smart contract may be associated with a group of associated unified memory payload packages as opposed to a single package. For example, if an individual has created 5 immersive memories the smart contract may apply the rules to the group of immersive memories as opposed to each individual immersive memory. For example, the smart contact may provide 5 replays of the immersive memories per week, and it does not matter whether you watch each memory once or one memory five times.

An NFT (nxNFT) is minted for the unified memory payload package based on an immutable reference to the unified memory payload package (e.g., external storage platform URI), metadata therefore and the smart contract logic 460. The metadata may include different parameters about the memory including, but not limited to, memory title, creator, timestamp, location, emotions, themes, and signature hash. The NFT (nxNFT) is used to provide access to unified memory payload packages so that an immersive presentation can be experienced.

As previously discussed, patients experiencing dementia or other neurodegenerative diseases may have problems remembering many things about their life, including their identity and their loved ones. The loss of memories and the inability to consistently know yourself or your loved ones may cause confusion, frustration and behavioral issues for the individual. One manner in which care givers, family and/or friends try to assist patients in these situations is to show them pictures or other mementoes from the past. The amount of memory stimulation and/or calming that this provides may be limited.

It is anticipated that the immersive presentations of the consolidated memories may be used to aid in the care of patients experiencing dementia or other neurodegenerative diseases. The immersive presentations may make the individual feel like they are back in time reliving an experience they previously had. The more realistic and nearly lifelike recreation of a memory may aid the memory of the patient (at least temporarily). Reliving an experience may help calm the individual when they are in an agitated state based on not knowing who they are, where they are and/or who the people around them are.

The individual experiencing dementia may be the one who created the immersive memories in the past. In such a case the immersive experience should have been reviewed by them and possibly validated as being authenticate based on, for example, comparisons to different benchmarks. If the individual created the immersive presentations, they may be in possession of the NFTs associated with the immersive memories (in their digital wallet) that validate ownership therein. According to one embodiment, the NFT is minted at time the immersive presentation was created. Alternatively, the NFT may not be minted until a point in time when there is a desire to experience the immersive presentation. The NFT (nxNFT) may provide various parameters associated with experiencing the immersive presentation. For example, the parameters may be associated with how many overall interactions, how many iterations per time period, whether the immersive presentation may be experienced by others, and if other immersive presentations are associated therewith.

By way of example, if the individual wants unlimited experiences of the immersive presentation from the day the day it is created, the system may charge them a first amount (may be a fairly high price). If the individual wants a limited number of experiences the system may charge a second amount (much less than first amount) to mint the NFT (nxNFT) with those parameters. If the individual selected a limited experience plan and they reached their limit and wanted to extend the limit, the individual may remint a new NFT for the immersive presentation defining new parameters.

As the individual gets older and their dementia or other neurodegenerative disease gets worse, it is unlikely that the individual will be able to select to experience an immersive memory on their own. As such, at some point the individual may provide a family member, friend or caregiver (collectively referred to as third party) with access to their digital wallet and the NFT (nxNFT) contained therein so that the 3rd party can access the immersive presentations.

It should be noted that if the immersive memories are not very accurate that a patient experiencing dementia may have an adverse reaction (e.g., become more confused or disoriented) to experiencing such an immersive presentation. Accordingly, there may be some analysis of whether a threshold of likelihood that the immersive presentation is realistic has been met, before the NFT (nxNFT) is minted therefore. The likelihood of being realistic threshold may be analyzed at various locations in the process. For example, it may be in the initial information gathering stage done by the individual, it may be when the additional information is found by the AI agent, it may be when the immersive presentation is created, or some combination thereof. The likelihood analysis may be based on comparisons of different parameters gathered to different benchmarks as discussed above. This threshold may be adjusted dynamically based on the patient's cognitive state, to ensure patient safety and minimize the risk of confusion or distress.

The above scenarios were described based on a dementia patient creating the immersive presentations while they were still capable. In another example, it is possible that friends and family create the immersive presentations for the patient when the patient is no longer capable of. This process may be similar to the process described above for the individuals but is based on the recollection of memories that are not from the patients perspective (are from other who partook) and may be third hand recollection (a son reliving a memory told to him by his father). In these situations, certain parameters may not be collected (e.g., party providing memories blood pressure) so there can be no comparison to benchmarks. To ensure these immersive memories meet a threshold likelihood of being realistic they may rely on gathering information from a plurality of others and/or ensuring the information collected by the memory teller(s) is aligned with the additional information gathered by the AI agent.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A system to enable users to provide information about memories of experiences they have had, create immersive presentations of the memories as digital assets, and utilize the digital asserts to treat those with neurodegenerative disease, the system comprising:
a processor; and
a computer readable medium instructions that when executed by the processor cause the processor to
present a user interface to an internet enabled device to enable the internet enabled device to collect information about the memory of the experience, wherein the information may be collected via text, audio or uploading, and wherein the information includes at least some subset of description of the experience; date, location, and environmental factors associated with the experience; images, videos, and audio associated with the experience;
utilize an artificial intelligence (AI) engine to gather publicly available information about the experience, consolidate the information collected from the user and the information gathered from the publicly available information, and create an immersive presentation of the memory of the experience;
encode the consolidated information that makes up the immersive memory into a unified memory payload package that is time stamped and content addressable via cryptographic hash;
record creation of the unified memory payload package on a tamper-evident registry;
encrypt the unified memory payload package;
store the encrypted unified memory payload package in an external storage platform;
mint a digital asset for the encrypted unified memory payload package including a smart contract that identifies parameters for the unified memory payload package including at least some subset of ownership and replay rights; and
present the immersive memory to an individual having a neurodegenerative disease who participated in the experience that the immersive memory captures the memory for.

2. The system of claim 1, wherein the tamper-evident registry includes a blockchain or a distributed ledger.

3. The system of claim 1, wherein the tamper-evident registry includes a directed acyclic graph ledger, a quantum-secure distributed system, a federated consensus registry, or a trusted execution environment attestation log.

4. The system of claim 1, wherein the external storage platform includes a decentralized content-addressable file system, a decentralized encrypted cloud storage, or a decentralized secure memory vault.

5. The system of claim 1, wherein the digital asset is a non-fungible token.

6. The system of claim 1, wherein the instructions further cause the processor to
collect biometric parameters, sensory metadata, and neural data gathered from the user as the information is collected from the user, and
validate the immersive presentation based on an analysis of some subset of biometric parameters, sensory metadata, and neural data gathered from the user.

7. The system of claim 1, wherein the immersive presentations are provided as a video.

8. The system of claim 1, wherein the immersive presentations are presented on virtual reality devices.

9. The system of claim 1, wherein the immersive presentations are presented on augmented reality devices.
